(19) United States
(12) Patent Application Publication
(10) Pub. No.: US 2007/0232113 A1
(43) Pub. Date: Oct. 4, 2007

(54) Electrical connector

(75) Inventor: Chien-Chih Ho, Anloku (TW)

Correspondence Address: BIRCH STEWART KOLASCH & BIRCH, PO BOX 747, FALLS CHURCH, VA, 22040-0747, US

(73) Assignee: Lotes Co., Ltd

(21) Appl. No.: 11/582,361

(22) Filed: Oct. 18, 2006

(30) Foreign Application Priority Data
Apr. 3, 2006 (TW) 095205539

(51) Int. Cl. H01R 13/62

(52) U.S. Cl. 439/331

(57) ABSTRACT

The objective of the invention is to provide an electronic connector with improved efficiency and low malfunction rate after being disassembled several times. In order to achieve the goal above, the electronic connector includes a base, a pressing plate, and a plurality of connecting members. A plurality of apertures is formed through the base. The connecting members are used for disposing the pressing plate on a circuit board. The connecting members include at least one first connecting member, wherein a lower end of the at least one first connecting member is connected with the circuit board, and an upper end of the at least one first connecting member is connected with a first end of the pressing plate. Comparing with prior art, the electronic connector, according to the invention, has higher efficiency and lower malfunction rate after several disassemblies.

### BACKGROUND OF THE INVENTION

1. Field of the Invention

The present invention relates to an electrical connector for increasing the efficiency of assembly and lowering the malfunction rate after several times of disassembling.

2. Description of the Prior Art

An electrical connector, according to the Chinese patent CN200420093999.0, includes a base, a top lid portion, and a fixing device. The fixing device is for fixing the electrical connector onto a circuit board. A plurality of apertures is formed on the top lid portion. The fixing device, including an immobile portion and a mobile portion capable of coping with each other, is capable of fixing the electrical connector onto a circuit board. The immobile portion is a nut soldered onto the circuit board. The mobile portion is a bolt which passes through an aperture to cope with the nut and presses on the upper surface of the top lid portion, for fixing the chip module onto the circuit board if the chip module is disposed on the base. When fixing an electrical connector onto a circuit board by the use of the fixing device, bolts are screwed one at a time into a nut. This leads to low efficiency in the fixing process and causes the nuts to be prone to damages, resulting in loose screwing.

Accordingly, the scope of the invention is to provide an electrical connector to resolve the problems described above.

### SUMMARY OF THE INVENTION

A scope of the invention is to provide an electrical connector for increasing the efficiency of assembly and lowering the malfunction rate after several times of disassembling.

According to a preferred embodiment of the invention, an electrical connector includes a base, a pressing plate, and a plurality of connecting members. A plurality of apertures is formed through the surfaces of the base. The connecting members are used for disposing the pressing plate on the circuit board. The connecting members include at least one first connecting member, wherein one end of the at least one first connecting member is connected with the circuit board, and another end of the at least one first connecting member is connected with a first end of the pressing plate.

Comparing with prior art, the electrical connector, according to the preferred embodiment of the invention, increases the efficiency of assembly and lowers the malfunction rate after several times of disassembling.

The advantage and spirit of the invention may be understood by the following recitations together with the appended drawings.

### BRIEF DESCRIPTION OF THE APPENDED DRAWINGS

FIG. 1 is a disassembly view of an electrical connector according to one preferred embodiment of the invention.

FIG. 2 is a partial disassembly view of the electrical connector according to one preferred embodiment of the invention.

FIG. 3 is an assembly view of the electrical connector according to one preferred embodiment of the invention.

FIG. 4 is a disassembly view of the electrical connector, according to an embodiment of the invention, wherein the lower ends of the first connecting member and the second connecting member are fixed to the circuit board by a screw thread.

FIG. 5 is a disassembly view of the electrical connector according to another preferred embodiment of the invention.

FIG. 6 is an assembly view of the electrical connector according to another preferred embodiment of the invention.

FIG. 7 is a disassembly view of the electrical connector, according to another preferred embodiment of the invention, wherein the lower ends of the first connecting member and the second connecting member are fixed to the circuit board by a screw thread.

### DETAILED DESCRIPTION OF THE INVENTION

Appended figures and embodiments below further describe the electronic connector according to the invention.

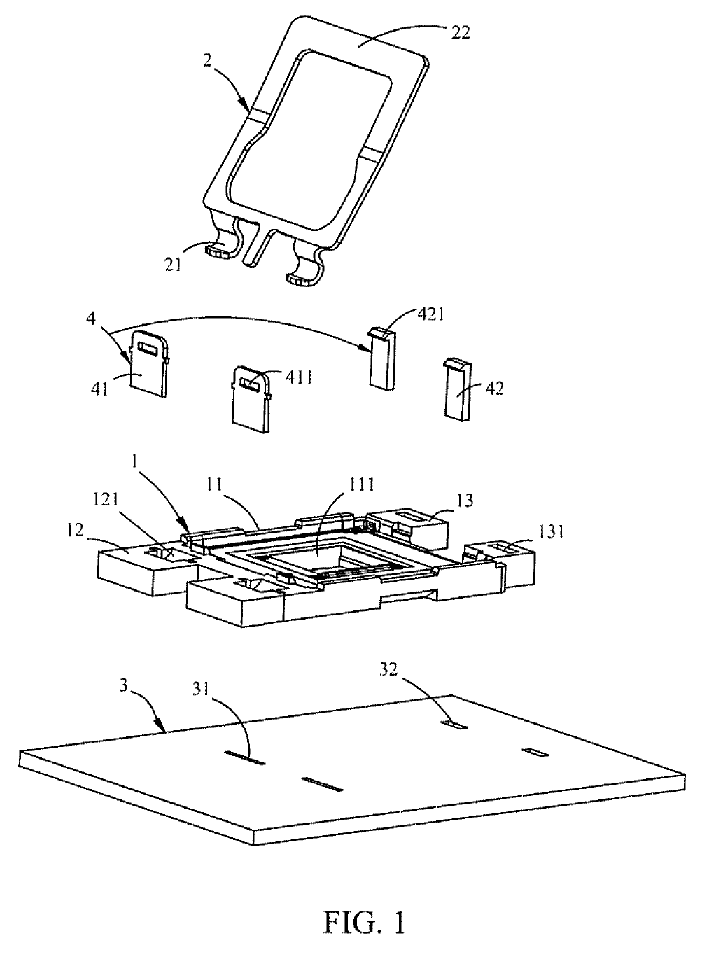

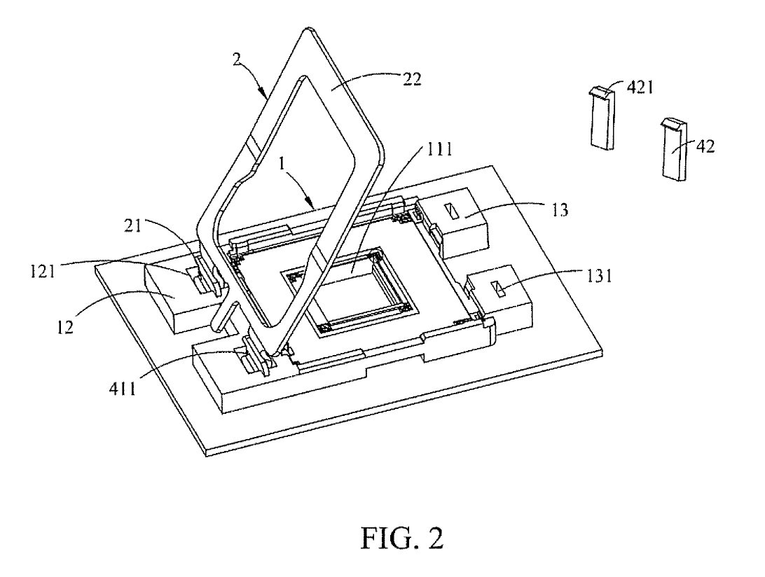

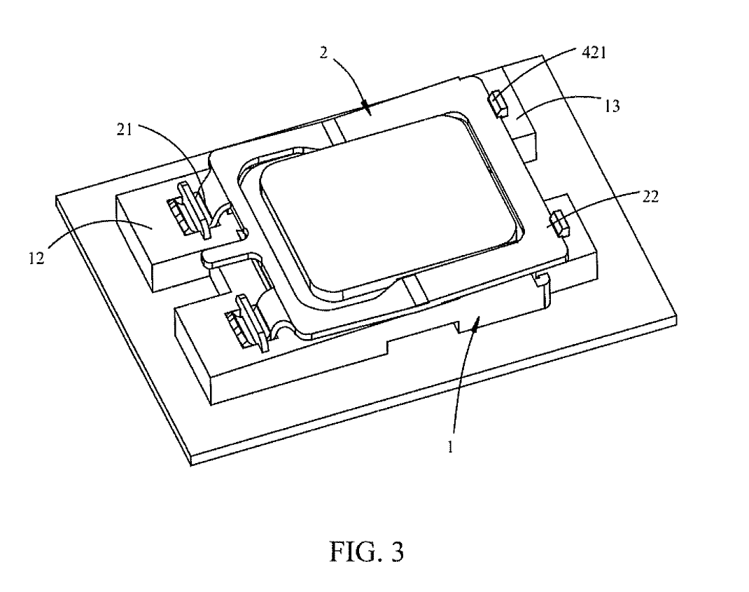

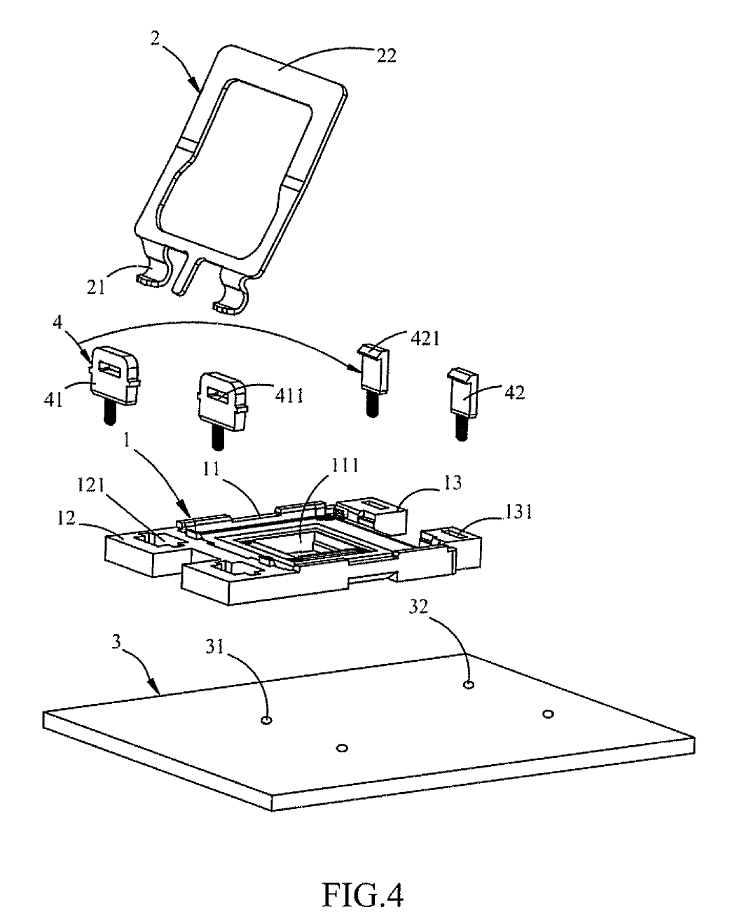

Referring to FIG. 1 through FIG. 4, FIG. 1 is a disassembly view of an electrical connector; FIG. 2 is a partial disassembly view of the electrical connector; FIG. 3 is an assembly view of the electrical connector; and FIG. 4 is a disassembly view of the electrical connector wherein the lower ends of the first connecting member and the second connecting member are fixed to the circuit board by a screw thread. According to a preferred embodiment of the invention, the electrical connector includes a base 1, a pressing plate 2, and a plurality of connecting members 4. The connecting members 4 are used for disposing the pressing plate 2 on a circuit board 3.

The base 1 includes a main body 11, a first connecting arm 12, and a second connecting arm 13. A cavity 111 for a chip module is formed in the middle of the main body 11. The first connecting arm 12 and the second connecting arm 13, both being detachable from each other, are formed by respective extensions from opposite ends of the main body 11. The first connecting arm 12 and the second connecting arm 13 each contains an aperture that is formed through the base 1. The apertures include a first insertion aperture 121 and a second insertion aperture 131.

A detachable pivotal connecting portion 21 is formed on one end of the pressing plate 2, and a clasping portion 22 is formed on the other end of the pressing plate 2.

A first retaining aperture 31 and a second retaining aperture 32, both corresponding to the lower ends of the connecting members, are formed on the electrical circuit board 3. The first retaining aperture 31 and the second retaining aperture 32 are both rectangular.

The connecting members 4, being substantially pillar-shaped, include a first connecting member 41 and a second connecting member 42. The first connecting member 41 has thereon a pivotal connecting aperture 411. The lower end of the first connecting member 41 passes through the first insertion aperture 121, inserts into the first retaining aperture 31 on the circuit board 3, and solders onto the circuit board 3. (The lower end of the first connecting member 41 and the circuit board 3 can also be fixed by a screw head, which only requires the lower end of the first connecting member 41 to be pillar-shaped with a screw thread, as shown in FIG. 4). The second connecting member 42 has thereon a clasp 421. The lower end of the second connecting member 42 passes through the second insertion aperture 131, inserts into the second retaining aperture 32 on the circuit board 3, and solders onto the circuit board 3. (The lower end of the second connecting member 42 and the circuit board 3 can also be fixed by a screw head, which only requires the lower end of the second connecting member 42 to be pillar-shaped with a screw thread, as shown in FIG. 4).

During assembly, the pivotal connecting portion 21 of the pressing plate 2 is pivoted to the pivotal connecting aperture 411 of the first connecting member 41. The lower end of the first connecting member 41 then passes through the first insertion aperture 121, inserts into the first retaining aperture 31 on the circuit board 3, and solders onto the circuit board 3. Furthermore, the lower end of the second connecting member 42 passes through the second insertion aperture 131, inserts into the second retaining aperture 32, and solders onto the circuit board 3. The chip module is then disposed within the cavity 111 for the chip module. The pressing plate 2 is disposed and pressed so that the clasp 421 on the second connecting member 42 clasps with the upper surface of the clasping portion 22 of the pressing plate 2.

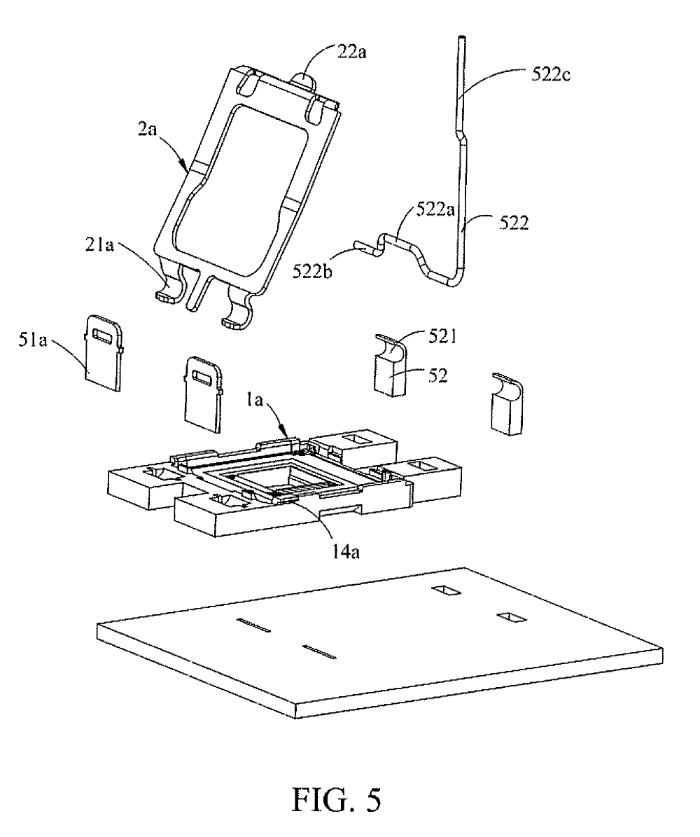

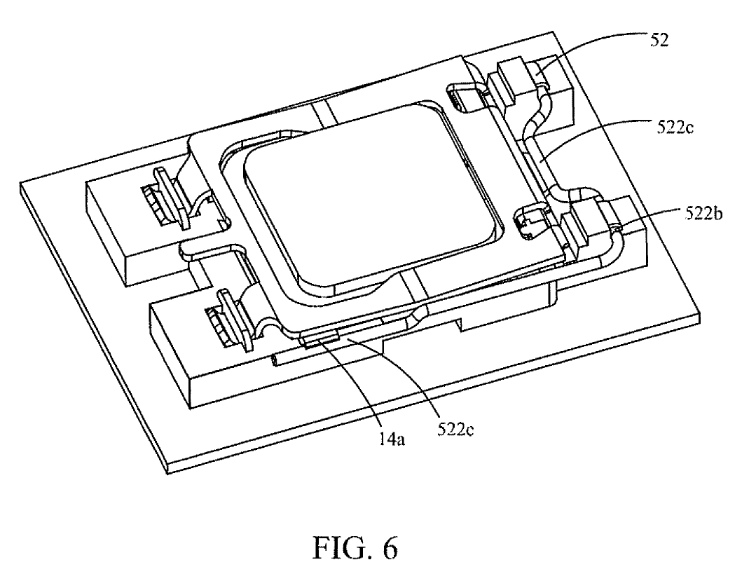

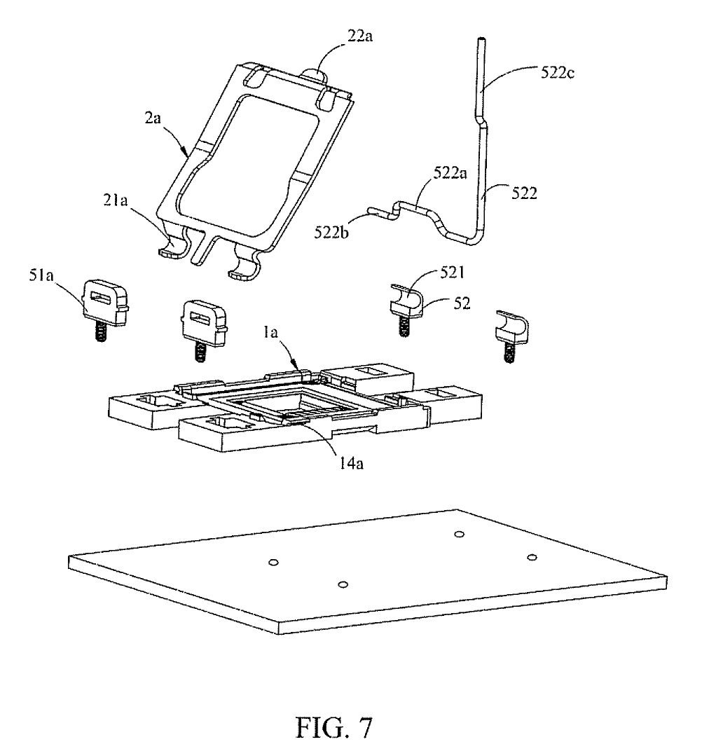

Referring to FIG. 5 and FIG. 6, FIG. 5 is a disassembly view of the electrical connector according to another preferred embodiment of the invention; and FIG. 6 is an assembly view of the electrical connector according to another preferred embodiment of the invention. Differing from the embodiment described above, a clasp portion 14a is formed by protruding from one side of the base 1a. A pivotal connecting portion 21a is formed on one end of the pressing plate 2a, and a pressing portion 22a is formed on the other end. A U-shaped pivotal connecting aperture 521 is formed on the upper part of the second connecting member 52. The second connecting member 52 further includes a rod 522 which includes a resisting portion 522a and a pivotal connecting axis portion 522b formed by extension from both ends of the resisting portion 522a. One end of the pivotal connecting axis portion 522b extends to form a connecting portion 522c. After disposing the pressing plate 2a, the resisting portion 522a of the rod 522 resists the pressing portion 22a of the pressing plate 2a, and the connecting portion 522c clasps with the clasping portion 14a on the base 1a. After assembly, the lower ends of the first connecting member 51a and the second connecting member 52a are soldered onto the circuit board. (The lower ends of the first connecting member 51a and the second connecting member 52a, as shown in FIG. 5 and FIG. 6, can also be fixed to the circuit board by a screw thread. This only requires the lower ends of the first connecting member 51a and the second connecting member 52a to be pillar-shaped with a screw thread, as shown in FIG. 7.)

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. An electrical connector comprising a base, a pressing plate, and a plurality of connecting members, a plurality of apertures being formed through the base, the connecting members being used for disposing the pressing plate on a circuit board, the connecting members comprising at least one first connecting member, wherein a lower end of the at least one first connecting member is connected with the circuit board, and an upper end of the at least one first connecting member is connected with a first end of the pressing plate.

2. The electrical connector of claim 1, wherein the connecting members further comprise at least one second connecting member passing through the aperture on the base, one end of the at least one second connecting member is connected with the circuit board, and the other end of the at least one second connecting member is connected with a second end of the pressing plate.

3. The electrical connector of claim 1, wherein the lower end of each connecting member is soldered with the circuit board.

4. The electrical connector of claim 1, wherein the lower end of each connecting member is fixed to the circuit board by a screw thread.

5. The electrical connector of claim 1, wherein the at least one connecting member is pivoted to the first end of the pressing plate.

6. The electrical connector of claim 5, wherein a pivotally connecting aperture is formed on each of the at least one first connecting member, at least one pivotally connecting portion is formed on one end of the pressing plate, and the pivotally connecting portion is capable of clasping with the pivotally connecting aperture.

7. The electrical connector of claim 2, wherein a clasp, installed on the at least one second connecting member, is capable of clasping with the pressing plate when the pressing plate is pressed down.

8. The electrical connector of claim 2, wherein the at least one second member comprises a rod capable of fixing the pressing plate when the pressing plate is pressed down.

9. The electrical connector of claim 1, wherein each of the connecting members is substantially pillar-shaped.
